(19) United States
(12) Patent Application Publication
(10) Pub. No.: US 2006/0074767 A1
(43) Pub. Date: Apr. 6, 2006

(54) Selective inclusion of stored value cards in mailings

(75) Inventors: Paul Matthew Fortney, Omaha, NE (US); Stephen Jay Hug, Omaha, NE (US); Glen David Wordekemper, Omaha, NE (US); Ronald L. Prchal, Plattsmouth, NE (US); Timothy James Horton, Papillion, NE (US); Martin G. Stivers, Glenwood, IA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: FIRST DATA CORPORATION, Englewood, CO (US)

(21) Appl. No.: 10/959,637

(22) Filed: Oct. 5, 2004

(51) Int. Cl. G06Q 30/00

(52) U.S. Cl. 705/26

(57) ABSTRACT

A method of including a gift card in a mailing to a customer includes receiving a request to include gift cards in mailings to each member of a group comprising one or more customers. The group includes the customer. The method also includes preparing the mailing. The mailing includes the gift card and the gift card is inactive. The method further includes sending the mailing to the customer and receiving a request from the customer to activate the gift card. The request includes an identifier of the gift card and payment for an amount of value to be assigned to the gift card. The method further includes settling a transaction involving the gift card and a recipient of the gift card. The recipient and the customer are different.

### CROSS-REFERENCES TO RELATED APPLICATIONS

This application is related to the following commonly assigned U.S. patent Applications, the entire disclosure of each of which are herein incorporated by reference for all purposes: U.S. patent application Ser. No. 10/028,449 (now U.S. Pat. No. 6,779,319, issued on Aug. 24, 2004), entitled “REAL-TIME INTELLIGENT PACKET-COLLATION SYSTEMS AND METHODS,” filed on Dec. 19, 2001; U.S. patent application Ser. No. 10/855,867, entitled “SYSTEM AND METHOD FOR INITIALIZING FINANCIAL PRESENTATION INSTRUMENTS,” filed on May 26, 2004; and U.S. patent application Ser. No. 10/417,887, entitled “SYSTEMS FOR ASSEMBLING MAILINGS AND METHODS FOR EXTERNAL CONTROL THEREOF,” filed on Apr. 14, 2003.

### BACKGROUND OF THE INVENTION

The present invention generally relates to financial presentation instruments. More specifically, the present invention relates to methods and systems for selectively including non-activated stored value cards, such as gift cards, and the like, in mailings.

Stored value cards, such as gift cards, pre-paid metered accounts, and the like, are well-known for providing access to goods and services. For example, stored value, or gift cards, may be purchased from various merchants such as Target®, Wal-Mart®, Starbucks®, Sears®, Blockbuster®, Macy's®, Banana Republic®, and the like. The purchase and usage of financial presentation instruments has continued to increase in recent years to the point that the sale of stored value cards today is a multi-billion dollar industry.

Given this rise in popularity, alternative distribution methods are needed. Unfortunately, however, stored value cards are nearly equivalent to cash, thus making postal distribution risky. Thus, systems and methods are needed that enable safe postal distribution of stored value cards.

Further, it would be advantageous to be able to target market stored value cards. It makes little sense to send a stored value card good only at a specific retailer to a consumer who never patronizes that retailer. Thus, systems and methods are needed to more effectively target market stored value cards.

### BRIEF SUMMARY OF THE INVENTION

Embodiments of the invention thus provide a method of including a gift card in a mailing to a customer. The method includes receiving a request to include gift cards in mailings to each member of a group comprising one or more customers. The group includes the customer. The method also includes preparing the mailing. The mailing includes the gift card and the gift card is inactive. The method further includes sending the mailing to the customer and receiving a request from the customer to activate the gift card. The request includes an identifier of the gift card and payment for an amount of value to be assigned to the gift card. The method further includes settling a transaction involving the gift card and a recipient of the gift card. The recipient and the customer are different.

In related embodiments, the value to be assigned to the gift card may be monetary value. The request may include criteria used to determine the group that includes one or more customers. Preparing the mailing may include applying the criteria to data stored at the host computer system to determine the group that includes the one or more customers. Receiving a request to include gift cards in mailings to each member of a group that includes the one or more customers may include receiving the request from a financial institution, retailer, client, and/or customer. The mailing may include an account statement, direct mailing, catalogue mailing, and/or account correspondence.

In other embodiments, a method of including a stored value card in a mailing to a customer includes receiving a request to include stored value cards in mailings to each member of a group that includes one or more customers. The group includes the customer. The method also includes preparing the mailing. The mailing includes the stored value card and the stored value card is inactive. The method also includes sending the mailing to the customer and receiving a request from the customer to activate the card. The request includes an identifier of the card and payment for an amount of monetary value to be assigned to the card.

In further embodiments, a method of including a gift card in a mailing to a customer includes receiving a request from the customer to include an inactive gift card in the mailing and preparing the mailing. The mailing includes the gift card and the gift card is inactive, The method also includes sending the mailing to the customer and receiving a request from the customer to activate the gift card. The request includes an identifier of the gift card and payment for an amount of monetary value to be assigned to the gift card. In some embodiments, the request includes a request to send a plurality of gift cards. At least two of the plurality of gift cards may relate to different merchants. The method may include settling transactions with two different recipients of two different of the plurality of gift cards. Receiving a request from the customer to include an inactive gift card in the mailing may include receiving a request to include a card in each of a plurality of mailings.

In still further embodiments, a computer-readable medium has stored thereon computer-executable instructions for performing a method of including a stored value card in a mailing to a customer. The method includes receiving a request to include stored value cards in mailings to each member of a group that includes one or more customers. The group includes the customer. The method also includes preparing the mailing. The mailing includes the stored value card and the stored value card is inactive. The method also includes sending the mailing to the customer and receiving a request from the customer to activate the card. The request includes an identifier of the card and payment for an amount of monetary value to be assigned to the card.

In still further embodiments, a method of including a stored value card in a mailing to a customer includes a step for receiving a request to include stored value cards in mailings to each member of a group that includes one or more customers. The group includes the customer. The method also includes a step for preparing the mailing. The mailing includes the stored value card and the stored value card is inactive. The method also includes a step for sending the mailing to the customer and a step for receiving a request from the customer to activate the card. The request includes an identifier of the card and payment for an amount of monetary value to be assigned to the card.

In some embodiments, a system for including a stored value card in a mailing to a customer includes mail processing equipment, a processor configured to control the mail processing equipment, and software that programs the processor to receive a request to include stored value cards in mailings to each member of a group that includes one or more customers. The group includes the customer. The software also programs the processor to send control signals to the mail processing equipment to prepare the mailing. The mailing includes the stored value card and the stored value card is inactive. The software also programs the processor to receive a request from the customer to activate the card. The request includes an identifier of the card and payment for an amount of monetary value to be assigned to the card. The request to include stored value cards in mailings to each member of a group comprising one or more customers may include criteria used to determine the group comprising one or more customers. The system may include a data storage arrangement configured to store account information relating to the one or more customers. The software may also program the processor to apply the criteria to the account information to determine the one or more customers.

In some embodiments, a system for including a stored value card in a mailing to a customer includes means for receiving a request to include stored value cards in mailings to each member of a group that includes one or more customers. The group includes the customer. The system also includes means for preparing the mailing. The mailing includes the stored value card and the stored value card is inactive. The system also includes means for sending the mailing to the customer and means for receiving a request from the customer to activate the card. The request includes an identifier of the card and payment for an amount of monetary value to be assigned to the card. The stored value card may be a gift card, in which case the system may include means for settling a transaction involving the gift card and a recipient of the card. The customer and the recipient may be different.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a system for selectively including stored value cards in mailings to customers according to embodiments of the invention.

FIG. 2 illustrates mail processing equipment used to assemble stored value card mailings according to embodiments of the invention.

FIG. 3 illustrates an exemplary stored value card mailing according to embodiments of the invention.

FIG. 4 illustrates a process for selectively including stored value cards in mailings according to embodiments of the invention, which process may be implemented in the system of FIG. 1.

### DETAILED DESCRIPTION OF THE INVENTION

According to embodiments of the invention, stored value cards are mailed to potential customers for activation and use. In some embodiments, the stored value cards comprise gift cards that the customer activates and presents to a recipient. The recipient thereafter may use the card for purchases of goods and services.

As used herein, the term “stored value card” refers to a presentation instrument that has a pre-determined amount of monetary value associated with it. The value may be physically encoded on the card or may be stored in a database that is accessed through a network when the card is presented for use to determine whether the card has sufficient value for the specific use. The card typically will have an information encoding region on it, which may be a magnetic stripe, a bar code, a “chip,” a radio frequency identification tag (RFID), or any other information encoding region. The term “card” is to be interpreted broadly so as to include fobs and such devices that interact with point-of-sale equipment to settle a transaction.

In some embodiments, the stored value cards are placed into mailings by a mail processor. Here, “processor” refers to any entity that assembles mailings. In some embodiments, the processor issues credit cards and other presentation instruments on behalf of its clients. The clients may be retailers, financial institutions, and the like. The presentation instruments may be: general use, network-branded credit cards (e.g., MASTERCARD®, VISA®, and the like); closed loop, private label credit cards (J.C.PENNEY'S®, TOYS-R-US®, and the like); co-branded cards issued jointly by a retailer and a financial institution; debit cards; gift cards; and the like. The processor also may settle transactions using the cards, send statements to the account holders, maintain the accounts of the account holders, and provide many other services for its clients.

In a specific embodiment, the stored value cards are gift cards. The cards may have no value or may have a predetermined value. In either case, however, the cards are not activated (i.e., “dead” cards). In the process of sending correspondence to the customers (i.e., account holders) of its clients (i.e., card issuers), a processor may insert dead gift cards in the mailings. Any of a number of different entities may cause the gift cards to be included in mailings. For example, a customer may specifically request a gift card for a particular merchant to be mailed to him along with his statement for a credit card of the merchant. In some embodiments the customer may access a web site and schedule gift cards for specific merchants at regular intervals or to correspond with events, such as his child's birthday, and the like. A client of the processor may request gift cards to be mailed to its customers along with their statements. The request may be based on criteria. For example, the client may request that every customer who has made a purchase at a specific retailer within the past six months receive a gift card for that retailer. Other criteria may relate to holidays, events specific to individual customers, a customer's creditworthiness as embodied in a FICO score, and many other criteria.

In some embodiments, a retailer may target market customers by sending gift cards via the processor. The retailer may have a credit card that the processor administers, in which case the retailer may use its own mailings to deliver the gift cards. In other embodiments, the retailer partners with a financial institution or other client of the processor to use its customer base and mailings to deliver the cards. In embodiments such as these, the retailer may be partly or exclusively a catalog retailer, and the mailing may include a catalog. Many other examples are possible.

Once a customer receives a card, the customer must activate the card. This may involve calling an IVR (i.e., interactive voice response) unit, logging onto a web site, calling a live agent, visiting a merchant, or the like. The customer provides information that identifies the card and a payment method. In embodiments that do not have a pre-established value associated with the card, the customer also provides an amount to load onto the card.

In some embodiments, the customer may present the card to a recipient who then may use the card for purchases of goods or services up to the pre-established amount or the amount loaded by the customer. Transactions involving the card may be settled by the processor. In some embodiments the recipient may add value to the card.

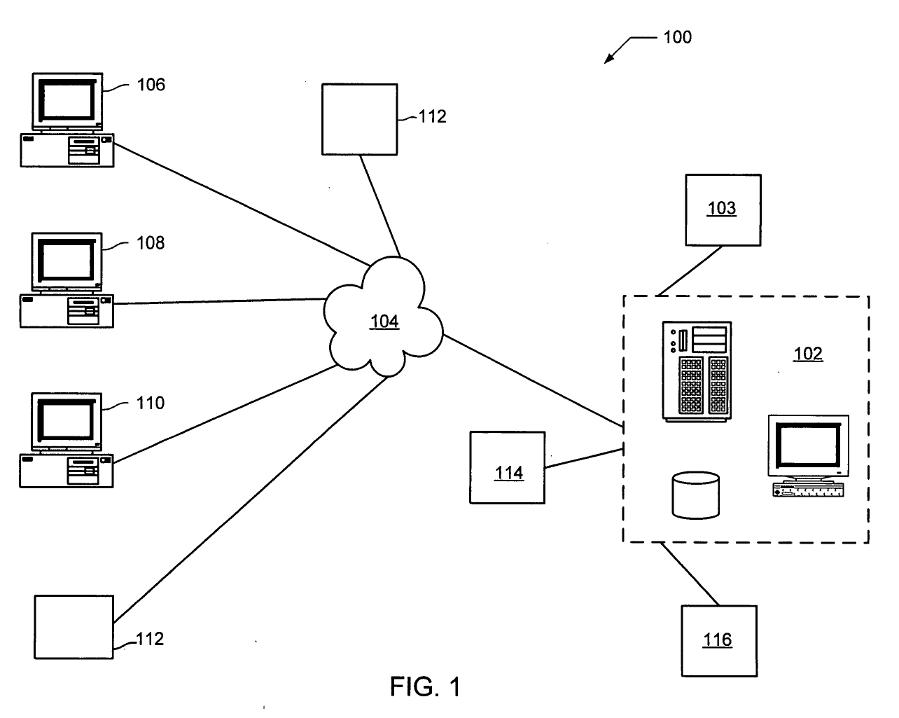

Having described the present invention generally, attention is directed to FIG. 1, which illustrates a system 100 according to the present invention. As will be explained in more detail hereinafter, the system 100 may be used to selectively include stored value cards in mailings to customers. It should be understood that, although the examples used herein relate to stored value cards, this is not a requirement. Other types of presentation instruments may be included in mailings to customers, as is apparent to those skilled in the art in light of this disclosure. Further, the system 100 of FIG. 1 should not be considered limiting. Those skilled in the art will realize equivalent arrangements in light of the disclosure herein.

The system 100 includes a host computer system 102. The host computer system 102 may include, for example, server computers, personal computers, workstations, web servers, and/or other suitable computing devices. The host computer system 102 includes application software that programs the host computer system 102 to perform one or more functions according to the present invention. For example, application software resident on the host computer system 102 may program the host computer system 102 to selectively include stored value cards in mailings to customers. The host computer system 102 may include one or more of the aforementioned computing devices, as well as storage devices such as databases, disk drives, optical drives, and the like. The storage device may include solid state memory, such as RAM, ROM, PROM, and the like, magnetic memory, such as disc drives, tape storage, and the like, and/or optical memory, such as DVD. The host computer system 102 may be fully located within a single facility or distributed geographically, in which case a network may be used to integrate the host computer system 102. Many other examples are possible and apparent to those skilled in the art in light of this disclosure.

In a specific embodiment, the host computer system includes a mainframe that maintains presentation instrument accounts and, in combination with a financial transaction processing network, settles transactions in which the presentation instruments are used.

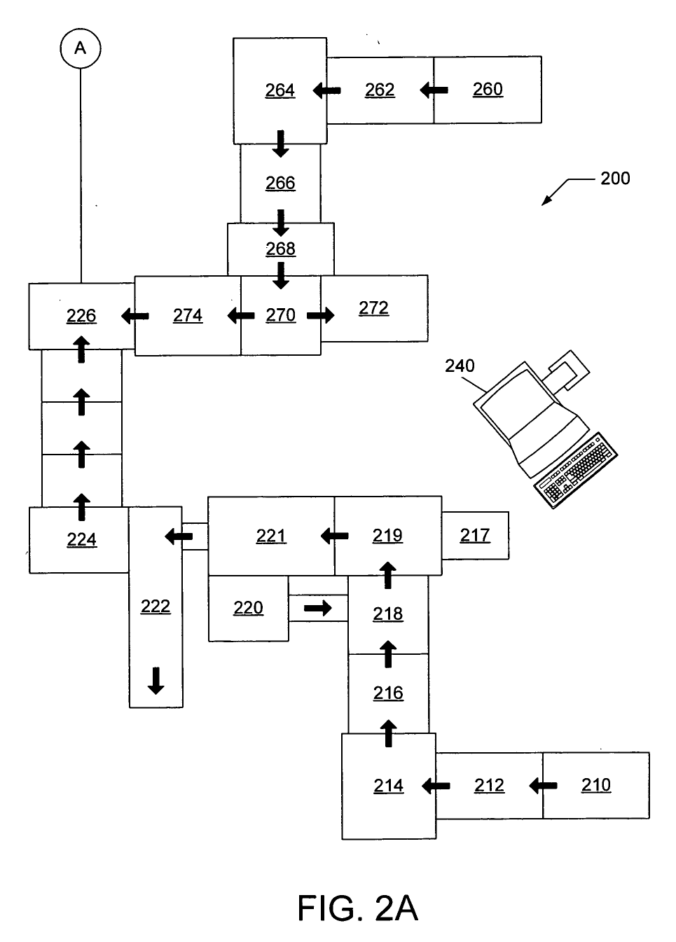

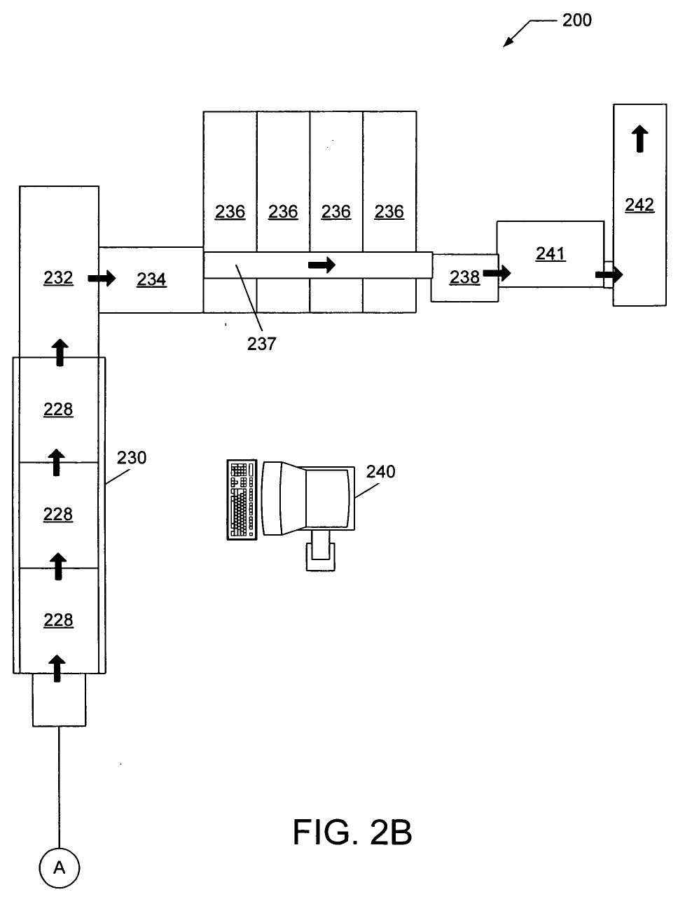

A mail processing system 103 is associated with the host computer system. The mail processing system 103 is responsive to the host computer system and performs such functions as: embossing presentation instruments; enclosing the presentation instruments in mailings to customers; printing and mailing statements to customers; including inserts and other items in mailings to customers; preparing and mailing other correspondence to customers; and the like. The mail processing system 103 will be explained in more detail hereinafter with respect to FIG. 2.

The system 100 also includes a communication network 104. The network 104 may be the Internet, an intranet, a wide area network (WAN), a local area network (LAN), a virtual private network, any combination of the foregoing, or the like. The network 104 may include both wired and wireless connections, including optical links. In some embodiments, the network 104 includes a financial transaction processing network. Through the network 104, client computers 106, customer computers 108, retailer computers 110, and the like communicate with the host computer system 102.

The client computers 106, customer computers 108, and retailer computers 110 each may be any device capable of interacting with the host computer system 102 through a communication link, such as the network 104. For example, the client computers 106, customer computers 108, and retailer computers 110 may be personal computers, workstations, servers, and/or the like. Among other things, through the network 104, the client computers 106, customer computers 108, and retailer computers 110 access web pages at the host computer system 102.

The system 100 also includes point-of-sale devices 112 through which customers may settle transactions a merchant locations using the presentation instruments described herein. The transactions then may be processed through the network 104, as will be appreciated by those skilled in the art.

The system 100 also includes an interactive voice response (IVR) unit 114, in communication with the host computer system 102, through which customers may activate stored value cards. The system 100 also includes a live agent response unit 116 for the same purpose.

Thus, when a customer receives a stored value card and wishes to activate it, the customer may use his customer computer 108 to access a web server associated with the host computer system 102 and provide appropriate information for activating the card. Alternatively, the customer may use a telephone to access either the IVR 114 or the live agent response unit 116 to activate the card. The web server, IVR, or the agent obtain the required information from the customer and create an account at the host computer system by creating a record that relates to the card on a database at the host computer system. Thereafter, transaction requests using the card that are processed via the network 104 use the stored information to settle the transaction. Those skilled in the art will appreciate, however, that it is not necessary for transactions using the card to be settled using the network 104. The system may be used to distribute stored valued cards that are settled on other networks.

Turning now to FIGS. 2A and 2B, an exemplary mail processing system will be described in greater detail. In particular, FIGS. 2A and 2B depict a simplified schematic of a mail processing and inserting system 200 useful in relation to the present invention. The mail processing system 200 may comprise the mail processing system 103 of FIG. 1. Those skilled in the art will appreciate that this exemplary embodiment is merely illustrative of myriad possible embodiments according to the present invention.

System 200 includes a series of stations adapted to produce an envelope stuffed with a desired number of primary components and/or inserts. System 200 can either receive folded primary components and/or inserts from a folding system, or can include printing and/or folding capability incorporated into the system. In the case shown in FIGS. 2A and 2B, system 200 includes a printer 210 adapted to print alpha numeric characters on a statement, a sheet of paper, a card carrier, or the like. Printer 210 prints information such as an account number, a customer name and mailing address, a monetary account limit, and the like, and further may print one or more bar codes. In one case, at least one of the bar codes identifies which inserts, from a plurality of different inserts, are to be sent to the customer with the statement or card.

The primary components (not shown) travel down a belt 212 and are stacked in a stacking unit 214. The primary components are then sequentially drawn from stacking unit 214 into unit 216. In one case, unit 216 includes a bar code reader for reading a bar code or other identification mark on the primary component. The bar code may, for example, identify which inserts are to be later matched up with the primary component. In another case, unit 216 also reads a number, such as a three digit number, associated with the primary component to facilitate proper matching with a card type insert having a corresponding number.

In one case, the primary component is transferred from unit 216 into unit 218. A card type insert is received from unit 220 and matched with the corresponding primary component in unit 218. In one case, the card type insert is glued, placed in slots or otherwise affixed to the primary component in unit 218. The mated card primary component and card are transferred to unit 219. If a processing error has occurred, unit 219 deflects the card and card primary component into a bypass tray or receiving area 217. Processing errors may include, for example, mismatched cards and card primary components, and the like. If no error has occurred, unit 219 deflects the card and card primary component into a folding unit 221. As previously noted, the folding unit can be implemented separately. From the folding unit, the primary component and associated card can be forwarded a card detection assembly, that when an error is detected, such as too many cards or a missing card(s), the primary component is transferred to a bypass tray or receiving area in the direction shown by arrow 123. Transfer may occur along a conveyor belt, a track, or the like.

In one particular case, system 200 operates to place card type inserts in primary components, but is not used for processing further paper inserts. In this case, the primary component and associated card type insert(s) are passed down conveyor 222 in the direction of arrow 223, and removed from system 200. The primary components may, if desired, be transported to an envelope stuffing apparatus, a mail room or the like. In another case, system 200 operates to place paper insert sets with primary components, but not card type inserts. In yet another case, system 200 operates to place both card and paper type inserts with primary components. In such cases, if the card detection assembly does not indicate an error, primary components are then passed to a paddle wheel assembly 224 to continue processing. The paddle wheel 224 operates to place the primary component and card type insert(s) on a track or conveyor belt 230. The primary components proceed down belt 230, passing under a second paddle wheel assembly 226. In one case, second paddle wheel assembly 226 places a second insert on top of the primary components as they pass underneath. For example, the second insert may be an advertisement, additional information pertinent to the recipient or the like.

As shown in FIG. 2A, a second printer 260 is adapted to print out the numerical characters and/or bar codes on an insert or a set of inserts. For example, printer 260 may further print one or more pages of advertisements or other inserts for a given recipient. In one case, printer 260 is electrically coupled to the bar code reader in unit 216. In this manner, bar code reader 216 may read the bar code or other identification mark on the primary component processed through unit 216 and inform printer 260 that an insert set is needed to be matched up with the primary component. In one case, controller 240 facilitates the communication between unit 216 and printer 260. The printed insert set passes from printer 260 along a belt 262 and into a stacking unit 264. Stacking unit 264 is similar to stacking unit 214, and performs similar functions. For example, stacking unit 264 stacks a plurality of primary components, and then passes the primary components one at a time to unit 266. Unit 266 is similar to unit 216, and may include a bar code reader for reading a bar code or other identification marks on the primary component. The insert then passes to unit 268, where the insert can be folded. The insert passes into unit 270, which in one case is a deflection unit 270 similar to unit 219 described above. Deflection unit 270 passes inserts to bypass station 272 in the event the insert is not to be matched with the present primary component. For example, bypass unit 272 receives inserts that may have been printed in error. Deflection unit 270 further directs inserts to belt 274 for transporting inserts to second paddlewheel 226. The insert is then matched with the primary component as described above.

In some embodiments, printer 260 is not included as all inserts are provided from pre-prepared inserts loaded into one or more insert bays or holders 228 that can be loaded with a variety of inserts. Alternatively, both printed and pre-prepared inserts can be included. The matched insert sets and primary components proceed along a track or conveyor belt 230, passing under one or more insert bays 228. FIG. 2B depicts three (3) insert bays 228, although a larger or smaller number of bays 228 also may be used within the scope of the present invention. In one particular case, system 200 includes as many as one hundred insert bays 228.

Insert bays 228 contain inserts, such as paper advertisements, catalogs, and informational inserts. These inserts may be added to a particular recipient's stack of primary components and/or card type inserts passing beneath on belt 230. Inserts contained within bays 228 may be selectively chosen based upon a number of criteria, including customer interest and other factors. For the system 200 shown in FIG. 2B having three bays 228, some recipients may receive all three inserts, other recipients may receive less than three inserts, while still other recipients may receive no inserts. The selected combination of inserts forms the insert set that is provided to the given recipient. In some cases, the insert set can include inserts from inert bays 228, the aforementioned card type inserts, and/or printed inserts created on printer 260.

In one case, the primary components traverse along belt 230 positioned underneath bays 228. In one case, belt 230 provides continuous, fluid movement of the statements. In another case, belt 230 provides incremental movement of the primary components, with each primary component stopping below each bin 228. Inserts desired to be matched with a particular recipient's primary component are pulled from bays 228 and placed atop the recipient's statement. Upon reaching the end of belt 230, the stack of primary components and associated inserts being sent to the recipient are transferred to unit 232 for insertion into an envelope.

The now stuffed envelope, containing a particular recipient's primary component, printed paper inserts, pre-prepared inserts, and/or card type inserts is sent to an envelope sealing unit 234. Envelope sealing unit 234 sprays a mist of water or other fluid on the envelope flap and proceeds to seal the moistened flap. Unit 234 further flips the stuffed envelope over to expose the envelope front. In one case, envelopes processed through system 200 are windowed envelopes, with information printed on the primary component or other insert exposed through the envelope window. The envelopes proceed into one or more diverters 236. Diverters 236 may divert stuffed envelopes for a variety of reasons, including, but not limited to, additional processing errors, and envelopes requiring special or additional handling. In one case, at least one diverter 236 is used for stuffed envelopes to be sent by overnight courier, such as Federal Express. In another case, at least one diverter is used to receive envelopes intended to be sent by airmail, or the like. Envelopes intended for standard mail delivery, such as by the U.S. Postal Service First Class Delivery, are put past diverters 236 along belt or track 237 and proceed to a first postage meter 238. First postage meter 238 applies a one ounce postage to envelopes requiring only a single ounce of postage. Envelopes proceed to a second postage meter unit 240, in which a second ounce of postage is applied. Alternatively, the entire two ounce postage is applied in second postage meter station 241, with the envelope passing first postage meter station 238 without receiving postage. The envelopes have now been properly stuffed, sealed, and postaged and proceed to an output station 242. The envelopes then may be received from output station 242 for delivery to the intended customers.

System 200, in one case, includes one or more controllers 240 for monitoring and/or controlling the process through system 200. The controller may receive instructions and commands from the host computer system 102 of FIG. 1. An operator may view the status of documents on the computer screen associated with a particular controller 240, and/or input data as needed into controller 240 to facilitate operation of system 200. Further, controllers 240 facilitate the coordination between printers 210, 260, bar code readers in system 200 and insert bays 228, to ensure each recipient receives the desired inset set. Additional information about an inserter similar to that previously described can be found in U.S. patent application Ser. No. 10/045,589, entitled “System And Methods Of Providing Inserts Into Envelopes,” filed Nov. 8, 2001, which was previously incorporated herein for all purposes. Based on the disclosure provided herein, one of ordinary skill in the art will appreciate that a variety of inserters and/or processing systems can be used in relation to the present invention. For example, another insertion system is disclosed in U.S. patent application Ser. No. 10/036,653, entitled “Mail Handling Equipment And Methods,” filed Nov. 8, 2001, and was also previously incorporated herein by reference for all purposes.

Thus, in a specific embodiment, the primary items discussed here may be statements and the inserts may be gift cards. In another specific embodiment, the primary components may be gift cards and the inserts may be catalogs. Many other examples are possible and apparent to those skilled in the art in light of this disclosure.

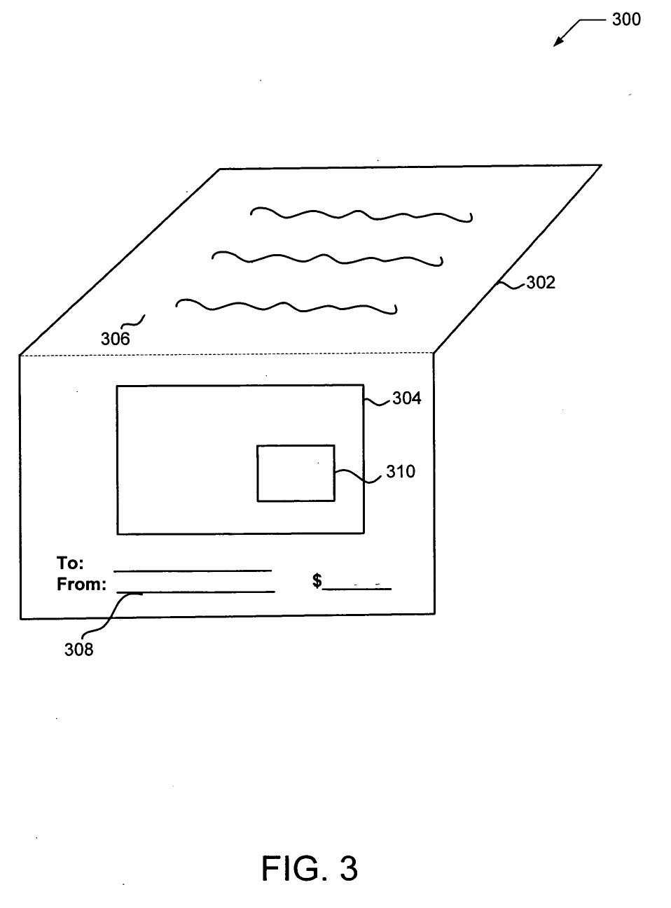

Attention is directed to FIG. 3, which illustrates an embodiment of a stored value card insert 300 according to embodiments of the invention. The insert 300 includes a card carrier 302 and a stored value card 304, in this case a gift card. The card 304 may be attached to the carrier 302 in any of a number of well known ways. The carrier 302 includes instructions 306 for activating the card and blanks 308 into which the customer may enter information such as the recipient and the amount the customer loaded on the card. Conveniently the carrier may be perforated so that the activation instructions section may be separated from the card section. The card may include a logo or brand 310.

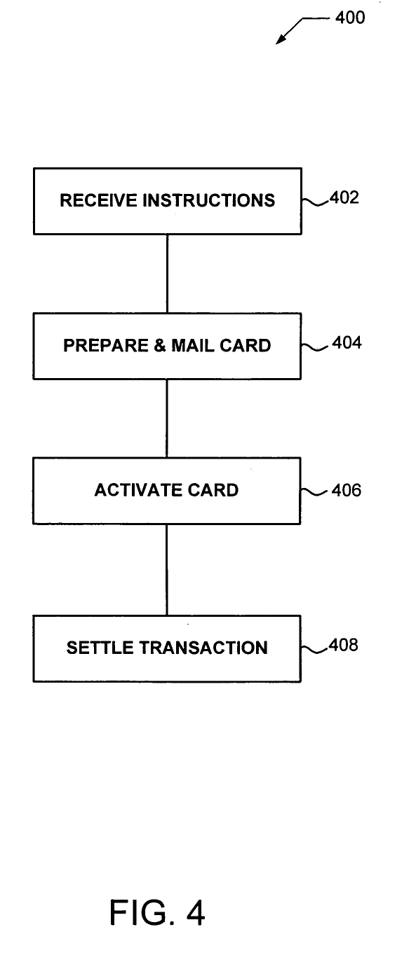

Attention is directed to FIG. 4, which illustrates an embodiment of a method 400 of selectively including stored value cards in mailings according to embodiments of the invention. The method may be implemented in the system of FIG. 1 or other appropriate system. The method 400 is merely exemplary; other embodiments may have more, fewer, or different operations. Further, the operations may be conducted in a different order than that illustrated here.

The method begins at block 402. At this location, a request is received at a host computer system to include stored value card inserts with one or more mailings. The host computer system is operated by a processing entity (“processor”). The request may originate from a client of the processor (e.g., card issuer), a retailer, a customer of the processor's client, or other entity. In most embodiments, however, the entity for whose benefit the mailing is prepared allows the insert to be included in the mailing, either for a fee or in cooperation with the requesting entity.

The request may come in any of a number of forms. The requesting entity may use a network, such as the network 104 of FIG. 1, to access a web server of the host computer system. By interacting with the web server, the entity may identify, either directly or via criteria, customers to whom the insert should be sent. As mentioned previously, the requesting entity may be a customer merely requesting a card for his own benefit. The customer may, using the web server, set up a recurring delivery schedule for such cards (e.g., every year just prior to Secretary's Day). The customer may request a number of cards, each to be delivered around a specific date. The cards need not be identical; the cards may each be useable at a different merchant.

At block 404, the mailing is prepared. This may involve using the mail processing system 103 of FIG. 1. In determining customers to whom the cards should be directed, the host computer may use the criteria to identify suitable customers. For example, the criteria may include parameters to send cards to all customers having an income level higher than $50K who have made a purchase at a specific retailer in the last six months. The criteria may be applied to data, such as account information, stored at the processor's host computer system. In some embodiments, a decisioning engine is used to parse the criteria and identify customers to whom cards are to be sent. Such a decision engine is described more fully in previously-incorporated U.S. patent application Ser. No. 10/417,887.

Once the customers have been identified, mail processing equipment, such as that described with respect to FIGS. 2A and 2B, may be used to selectively include cards in mailings to the customers. The mailings may be a regular mailing, such as an account statement, or the like, or may be targeted marketing specifically intended to deliver the card. Many other examples are possible.

At block 406, an activation request is received. A customer contacts the host computer to request activation of a card. The customer may contact the host computer system via a network and interact with a web server. In other embodiments, the customer contacts an IVR or a live agent and activates the card. In some embodiments, activating a card comprises establishing an account and storing a record of the account at the host computer system. The activation request may include an amount of value to be assigned to the card, since some cards do not have predetermined value.

At block 408, transactions involving the card are settled. This would be the case if the processor that issues the card also settles transactions using the card, which is not necessarily the case. Transactions involving the card may be settled by another processor's network.

In a specific embodiment of the foregoing method, a retailer (Toys-R-Us®, for example) partners with a financial institution (Chase®, for example) to provide its customers with a co-branded gift card that may be used for purchases at Toys-R-Us® stores or for Toys-R-Us® merchandise ordered via a catalog or an electronic storefront (i.e., web site). The financial institution happens to be the card issuer for the retailer's private label card. The financial institution instructs the entity that processes its credit card transactions (“processor”) to, with each customer's account statement, send a gift card to each of its customers who have purchased at the retailer in the last 12 months. The financial institution further asks that customers living in a zip code more than 50 miles from a location of the retailer also receive a catalog of the retailer. The processor prepares the mailings and distributes the cards. Thereafter, the processor may receive requests to activate the cards, in which case, the processor receives payment and establishes the related accounts. In this embodiment, the processor also processes transactions involving the gift card. Thus, when a recipient of the card uses the card, the processor settles the transaction.

Having described several embodiments, it will be recognized by those of skill in the art that various modifications, alternative constructions, and equivalents may be used without departing from the spirit of the invention. For example, those skilled in the art will realize that the teachings herein are not limited to selectively including stored value cards in mailings. Other types of presentation instruments also may be included in mailings according to the teachings herein. Additionally, a number of well known processes and elements have not been described in order to avoid unnecessarily obscuring the present invention. For example, those skilled in the art know how to arrange computing devices into a network and configure communication among them. Accordingly, the above description should not be taken as limiting the scope of the invention, which is defined in the following claims.

What is claimed is:

1. A method of including a gift card in a mailing to a customer, comprising:
at a host computer system, receiving a request to include gift cards in mailings to each member of a group comprising one or more customers, wherein the group includes the customer;
preparing the mailing, wherein the mailing includes the gift card and wherein the gift card is inactive;
sending the mailing to the customer;
at a host computer system, receiving a request from the customer to activate the gift card, wherein the request includes an identifier of the gift card and payment for an amount of value to be assigned to the gift card;
thereafter, at the host computer, settling a transaction involving the gift card and a recipient of the gift card, wherein the recipient and the customer are different.

2. The method of claim 1, wherein the value to be assigned to the gift card comprises monetary value.

3. The method of claim 1, wherein the request includes criteria used to determine the group comprising one or more customers.

4. The method of claim 3, wherein preparing the mailing comprises applying the criteria to data stored at the host computer system to determine the group comprising one or more customers.

5. The method of claim 1, wherein receiving a request to include gift cards in mailings to each member of a group comprising one or more customers comprises receiving the request from a selection from the group consisting of financial institution, retailer, client, and customer.

6. The method of claim 1, wherein the mailing comprises a selection from the group consisting of account statement, direct mailing, catalogue mailing, and account correspondence.

7. A method of including a stored value card in a mailing to a customer, comprising:
at a host computer system, receiving a request to include stored value cards in mailings to each member of a group comprising one or more customers, wherein the group includes the customer;
preparing the mailing, wherein the mailing includes the stored value card and wherein the stored value card is inactive;
sending the mailing to the customer; and
at the host computer system, receiving a request from the customer to activate the card, wherein the request includes an identifier of the card and payment for an amount of monetary value to be assigned to the card.

8. The method of claim 7, wherein the request to include stored value cards in mailings to each member of a group comprising one or more customers includes criteria used to determine the group comprising one or more customers.

9. The method of claim 8, wherein preparing the mailing comprises applying the criteria to data stored at the host computer system to determine the one or more customers.

10. The method of claim 7, wherein receiving a request to include stored value cards in mailings to each member of a group comprising one or more customers comprises receiving the request from a selection from the group consisting of financial institution, retailer, client, and customer.

11. The method of claim 7, wherein the mailing comprises a selection from the group consisting of account statement, direct mailing, catalogue mailing, and account correspondence.

12. The method of claim 7, wherein receiving a request from the customer to activate the card comprises receiving an amount of monetary value to be assigned to the card.

13. A method of including a gift card in a mailing to a customer, comprising:
at a host computer system, receiving a request from the customer to include an inactive gift card in the mailing;
preparing the mailing, wherein the mailing includes the gift card and wherein the gift card is inactive;
sending the mailing to the customer;
at a host computer system, receiving a request from the customer to activate the gift card, wherein the request includes an identifier of the gift card and payment for an amount of monetary value to be assigned to the gift card.

14. The method of claim 13, wherein the request from the customer to include an inactive gift card in the mailing comprises a request to send a plurality of gift cards.

15. The method of claim 14, wherein at least two of the plurality of gift cards relate to different merchants.

16. The method of claim 14, further comprising thereafter settling transactions with two different recipients of two different of the plurality of gift cards.

17. The method of claim 13, wherein receiving a request from the customer to include an inactive gift card in the mailing comprises receiving a request to include a card in each of a plurality of mailings.

18. A computer-readable medium having stored thereon computer-executable instructions for performing a method of including a stored value card in a mailing to a customer, the method comprising:
receiving a request to include stored value cards in mailings to each member of a group comprising one or more customers, wherein the group includes the customer;
preparing the mailing, wherein the mailing includes the stored value card and wherein the stored value card is inactive;
sending the mailing to the customer; and
receiving a request from the customer to activate the card, wherein the request includes an identifier of the card and payment for an amount of monetary value to be assigned to the card.

19. The method of claim 18, wherein the request to include stored value cards in mailings to each member of a group comprising one or more customers includes criteria used to determine the group comprising one or more customers.

20. The method of claim 18, wherein preparing the mailing comprises applying the criteria to data stored at the host computer system to determine the one or more customers.

21. The method of claim 18, wherein the stored value card comprises a gift card and wherein the method further comprises settling a transaction with a recipient of the card.

22. A method of including a stored value card in a mailing to a customer, comprising:
a step for receiving a request to include stored value cards in mailings to each member of a group comprising one or more customers, wherein the group includes the customer;
a step for preparing the mailing, wherein the mailing includes the stored value card and wherein the stored value card is inactive;
a step for sending the mailing to the customer; and
a step for receiving a request from the customer to activate the card, wherein the request includes an identifier of the card and payment for an amount of monetary value to be assigned to the card.

23. The method of claim 22, further comprising:
a step for settling a transaction involving the card and a recipient of the card.

24. A system for including a stored value card in a mailing to a customer, comprising:
mail processing equipment;
a processor configured to control the mail processing equipment; and
software that programs the processor to:
receive a request to include stored value cards in mailings to each member of a group comprising one or more customers, wherein the group includes the customer;
send control signals to the mail processing equipment to prepare the mailing, wherein the mailing includes the stored value card and wherein the stored value card is inactive; and
receive a request from the customer to activate the card, wherein the request includes an identifier of the card and payment for an amount of monetary value to be assigned to the card.

25. The system of claim 24, wherein the request to include stored value cards in mailings to each member of a group comprising one or more customers comprises criteria used to determine the group comprising one or more customers.

26. The system of claim 25, further comprising a data storage arrangement configured to store account information relating to the one or more customers.

27. The system of claim 26, wherein the software further programs the processor to apply the criteria to the account information to determine the one or more customers.

28. A system for including a stored value card in a mailing to a customer, comprising:
means for receiving a request to include stored value cards in mailings to each member of a group comprising one or more customers, wherein the group includes the customer;
means for preparing the mailing, wherein the mailing includes the stored value card and wherein the stored value card is inactive;
means for sending the mailing to the customer; and
means for receiving a request from the customer to activate the card, wherein the request includes an identifier of the card and payment for an amount of monetary value to be assigned to the card.

29. The system of claim 28, wherein the request to include stored value cards in mailings to each member of a group comprising one or more customers comprises criteria used to determine the group comprising one or more customers, the system further comprising:
means for applying the criteria to account information stored at the system.

30. The system of claim 28, wherein the stored value card comprises a gift card, the system further comprising:
means for settling a transaction involving the gift card and a recipient of the card, wherein the customer and the recipient are different.
